(19) United States
(12) Patent Application Publication
(10) Pub. No.: US 2016/0037386 A1
(43) Pub. Date: Feb. 4, 2016

(54) CONTROLLING BANDWIDTH ON CLIENT BASIS IN WLAN

(71) Applicant: QUALCOMM Incorporated, San Diego, CA (US)

(72) Inventors: Vijayaraja Pitchaiah, Thanjavur (IN); Ramachandran Ranganathan, Chennai (IN); Bala Shanmugam Shanmugam Kamatchi, Chennai (IN)

(21) Appl. No.: 14/447,204

(22) Filed: Jul. 30, 2014

(51) Int. Cl. H04W 28/20; H04W 84/12

(52) U.S. Cl. CPC H04W 28/20; H04W 84/12

(57) ABSTRACT

Techniques are described for controlling the data rate of individual or groups of client devices in a network such as a Wireless Local Area Network (WLAN). In one aspect, a method may include grouping a plurality of client devices into at least one group, the grouping being unassociated with a traffic class of the plurality of client devices. The method may also include determining channel characteristic thresholds, such as one or more of a bandwidth threshold, message size threshold, throughput threshold, or an optional service requirement, for the at least one group of client devices, and controlling a data rate for the at least one group of client devices based at least in part on the determined channel characteristic thresholds. In some aspects, different channel characteristic thresholds may be applied to uplink and/or downlink communications with the client device.

### FIELD OF THE DISCLOSURE

The following relates generally to wireless communications, and more specifically to controlling data rates and bandwidth for individual client devices or groups of client devices in a wireless local area network (WLAN).

### DESCRIPTION OF RELATED ART

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Wireless Local Area Networks (WLANs), such as Wi-Fi (IEEE 802.11) networks are widely deployed and used. Other examples of such multiple-access systems may include code-division multiple access (CDMA) systems, time-division multiple access (TDMA) systems, frequency-division multiple access (FDMA) systems, and orthogonal frequency-division multiple access (OFDMA) systems.

Generally, a wireless multiple-access communications system may include a number of base stations or access points (APs), each simultaneously supporting communication for multiple mobile, client devices, or stations (STAs). Some WLANs may support Peer to Peer (P2P) connections (e.g., Wi-Fi P2P or Wi-Fi Direct). A client device may be elected to operate as a soft-AP or Group Owner (GO) for communications with other Wi-Fi devices. The GO may organize a P2P group and act as an AP for other devices. Wi-Fi Direct enables the formation of a P2P group directly between two devices, resulting in reduced network setup time and procedures, increased network flexibility, etc. APs, which may also include soft APs as described herein, may communicate with STAs on downstream and upstream links (UL and DL, respectively) on one or more channels. Each AP has a coverage range, which may be referred to as the coverage area of the cell. A WLAN, such as a WiFi network, may include multiple APs.

In current WLAN implementations, the amount of traffic on a given channel may be limited based on a particular type or class of traffic, such as video, voice, etc. The amount of traffic may be limited using various techniques, such as an Admission Control Mandatory (ACM) scheme. ACM schemes, however, do not enable limiting traffic based on other characteristics that are unassociated with traffic class. Quality of Service (QoS) may also be used as a metric to limit access to a wireless medium to ensure a minimum bandwidth is available for a given channel. These traffic control techniques, however, do not provide for an adaptable way to limit traffic in a WLAN based on metrics unassociated with traffic class or QoS.

### SUMMARY

The described features generally relate to improved systems, methods, and/or apparatuses for controlling a data rate or bandwidth for individual client devices, or at least a group of client devices, based on at least a channel characteristic threshold. In particular, the described techniques may include grouping a plurality of client devices in a wireless local area network (WLAN) into at least one group, the grouping of the plurality of client devices being unassociated with a traffic class of the plurality of client devices. Client devices, also referred to herein as stations (STAs), may be grouped together based on data usage, geographic location, service requirements, priority, randomly, or the like. The described techniques may include determining at least one channel characteristic threshold(s) for each group of client devices. The channel characteristic threshold(s) may include a minimum bandwidth threshold, a maximum bandwidth threshold, a message size threshold, a throughput threshold, or an optional service requirement (e.g., for carrier Wi-Fi). The described techniques may further include controlling a data rate for each group of client devices based on the determined channel characteristic threshold(s). Controlling the data rate may be performed separately on the uplink, downlink, or both, for example, by utilizing an uplink channel characteristic threshold, a downlink channel characteristic threshold, or a combination thereof.

In some implementations, an AP, soft AP, or other network device (e.g., according to instructions received via a user interface) may perform the described techniques. The client devices in each group may support two or more types of traffic (e.g., video, voice, etc.), two or more types or levels of priority (e.g., based on traffic, connection type, level of service further based on purchase, etc.), or both.

In some embodiments, controlling the data rate for each group of client devices may include communicating the channel characteristic threshold(s) to at least one client device in the group. A client device may transmit a message to an AP including traffic information associated with the client device. The AP may then adapt the supported data rate for the client device and any other client devices in the same group/network based on the traffic information. In some cases, the traffic information may include data usage pattern information, type information of a client device (e.g., whether the client device is a mobile device, a tablet, laptop, etc.), priority of access information, etc., for at least one client device in the group or network. The AP may detect a change in traffic in the WLAN and adapt a channel characteristic threshold for at least one group of client devices based on the detected change in traffic. In some scenarios, the WLAN may adapt the channel characteristic thresholds to maximize limited bandwidth resources of the AP or in the WLAN, such as to provide a minimum required level of throughput to at least one group of client devices. In yet some scenarios, the AP may reorganize the client devices in at least one group based on received traffic information or changes in traffic in the WLAN.

In some embodiments, an AP may communicate the channel characteristic threshold(s) by transmitting an information element (IE) to a client device. The IE may include channel characteristic thresholds (e.g., bandwidth limitations, message size limitation, etc.), and a threshold application indication, a threshold direction indication, or a group identification, or a combination thereof.

In some aspects, the AP may communicate a first channel characteristic threshold to a first group of client devices and a second channel characteristic threshold to a second group of client devices. The AP may additionally tag the first group of client devices with a first category and a first priority and tag the second group of client devices with a second category and a second priority.

Some embodiments may include a wireless communications device that further includes a client device grouping module to group a plurality of client devices into at least one group, where the grouping of the plurality of client devices is unassociated with a traffic class of the plurality of client devices. The wireless communications device may additionally include a channel characteristic threshold module to determine channel characteristic thresholds for the at least one group of client devices, and a data rate controller to control a data rate for the at least one group of client devices based at least in part on the determined channel characteristic thresholds.

In some aspects, the data rate controller may communicate the channel characteristic thresholds to at least one of the plurality of the client devices in the at least one group. In some cases, the channel characteristic threshold module may receive a first message from the at least one client device in response to the communicating and adapt the channel characteristic thresholds for the at least one group of client devices based on the received first message.

In some aspects, the channel characteristic threshold module may detect a change in traffic in the WLAN and adapt the channel characteristic thresholds for the at least one group of client devices based on the detected change in traffic.

Some embodiments may include an apparatus that further includes means for grouping a plurality of client devices into at least one group, with the grouping of the plurality of client devices being unassociated with a traffic class of the plurality of client devices. The apparatus may further include means for determining channel characteristic thresholds for the at least one group of client devices, and means for controlling a data rate for the at least one group of client devices based at least in part on the determined channel characteristic thresholds.

Further scope of the applicability of the described methods and apparatuses will become apparent from the following detailed description, claims, and drawings. The detailed description and specific examples are given by way of illustration only, since various changes and modifications within the scope of the description will become apparent to those skilled in the art.

### BRIEF DESCRIPTION OF THE DRAWINGS

A further understanding of the nature and advantages of the present disclosure may be realized by reference to the following drawings. In the appended Figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a wireless communications system in accordance with various embodiments;

FIG. 2 shows a block diagram of an exemplary wireless communication system including an Access Points (AP) in communication with two groups of client devices or stations (STAs), in accordance with various embodiments;

FIG. 3 shows a block diagram of an exemplary wireless communication system including a network device in communication with multiple groups of client devices via multiple APs, in accordance with various embodiments;

FIG. 4 shows a flow diagram of an AP assigning a client device to an existing group of client devices at a first data rate, in accordance with various embodiments;

FIG. 5 shows a flow diagram of an AP adjusting a data rate of communications with a client device based on updated traffic information, in accordance with various embodiments;

FIG. 6 shows a flow diagram of a client device adapting to a supported data rate of an AP, in accordance with various embodiments;

FIG. 7 shows a block diagram of an example of an Information Element (IE) for communicating supported UL and DL data rates to a client device, in accordance with various embodiments;

FIG. 8 shows a block diagram illustrating a device for controlling a data rate of at least one group of client devices, in accordance with various embodiments;

FIG. 9 shows a block diagram illustrating another device for controlling a data rate of at least one group of client devices, in accordance with various embodiments;

FIG. 10 shows a block diagram of a device configured for controlling a data rate of at least one group of client devices, in accordance with various embodiments; and

FIGS. 11-13 illustrate flowcharts of methods for controlling a data rate of at least one group of client devices, in accordance with various embodiments.

### DETAILED DESCRIPTION

The described features generally relate to improved systems, methods, and/or apparatuses for controlling a data rate or bandwidth for individual client devices or a group of client devices. In one example, a plurality of client devices in a WLAN may be grouped together, the grouping being unassociated with or independent of a traffic class of the plurality of client devices. The data rate of individual client devices or the group of device may be controlled based on channel characteristic thresholds. Examples of channel characteristic thresholds may include bandwidth thresholds, a message size threshold, a throughput threshold, and/or optional service requirement(s) (e.g., for carrier Wi-Fi), etc. The channel characteristic thresholds may be applied on the uplink, downlink, or both links.

In some implementations, an AP, soft AP, or other network device (collectively referred to as an AP), or combination thereof, may perform the described techniques. The AP may group client devices based on data usage, geographic location, service requirements, priority, randomly, or based on other organization schemes. The AP may group the client devices to enable different types of priority access to the served WLAN of the AP, for example, by device type, by price or level of service purchased by users of the client devices in the WLAN, etc. The AP may additionally or alternatively group the client devices based on minimum service requirements, to maintain fairness or equality of bandwidth usage in the WLAN, to manage the congestion level in the WLAN, etc. The client devices in each group may support two or more types of traffic (e.g., video, voice, etc.), two or more types or levels of priority (e.g., based on traffic, connection type, level of service further based on purchase, etc.), or both.

The AP may determine a channel characteristic threshold for each group of client devices, for example, based on data usage patterns of the client devices in the group and/or in the served WLAN, based on traffic or congestion in the WLAN, based on the metrics used to group the client devices, etc. The AP may then control the data rate for each group of client devices based on the determined channel characteristic threshold(s), such as by communicating the channel characteristic threshold(s) to client devices in the group. In some aspects, the AP may communicate a first channel characteristic threshold to a first group of client devices and a second channel characteristic threshold to a second group of client devices. The AP may additionally tag the first group of client devices with a first category and a first priority and tag the second group of client devices with a second category and a second priority.

In some aspects, the AP may control the data rate by communicating an Information Element (IE) including the channel characteristic threshold(s) to a client device. The IE may include channel characteristic thresholds (e.g., UL or DL bandwidth limitations, message size limitation(s), bandwidth limitation(s), etc.), a threshold application indication, a threshold direction indication, or a group identification, or a combination thereof. The threshold application indication may indicate when the channel characteristic threshold(s) should be applied, such as unrestricted, restricted to a maximum value, or variable. The threshold direction indication may indicate the direction the channel characteristic threshold(s) should be applied, such as on the uplink and/or downlink. The group identification may indicate to which group the client device has been assigned, such as a default group, or another group supporting a different bandwidth.

Upon receiving the IE, a client device may compare the channel characteristic threshold(s) (e.g., data rate) indicated in the IE with the specifications supported by the Medium Access Control (MAC) layer of the client device. If the client device does not support the channel characteristic threshold(s) indicated in the IE, the client device may ignore the IE and continue to communicate with the AP until the AP acknowledges the client device. For example, the client device may incrementally lower the data rate or other metric associated with communications with the AP until the AP acknowledges the communication.

In some embodiments, a client device may transmit a message to an AP including traffic information associated with the client device. The AP may adapt the supported data rate for the client device, and any other client devices in the same or different group, based on the traffic information. In some cases, the traffic information may include data usage pattern information for at least one client device in the group, type information of a client device in the group (e.g., whether the client device is a mobile device, a tablet, laptop, etc.), priority of access information for a client device in the group, etc. In some embodiments, the traffic information may be associated with other client devices and/or other groups. In yet some cases, the AP may detect a change in traffic in the WLAN and adapt a channel characteristic threshold for at least one group of client devices based on the detected change in traffic. In some scenarios, the AP may adapt the channel characteristic thresholds to maximize limited bandwidth resources of the AP or in the WLAN, provide a minimum required level of throughput to at least one group of client devices, or the like. In yet some scenarios, the AP may reorganize the client devices in at least one group based on changes in traffic in the WLAN or based on received traffic information.

The following description provides examples and is not limiting of the scope, applicability, or configuration set forth in the claims. Changes may be made in the function and arrangement of elements discussed without departing from the scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments. For the purposes of explanation, the described methods, systems, and devices refer specifically to at least one WLAN; however, other radio communication or access technologies may be compatible with and implemented using the described techniques.

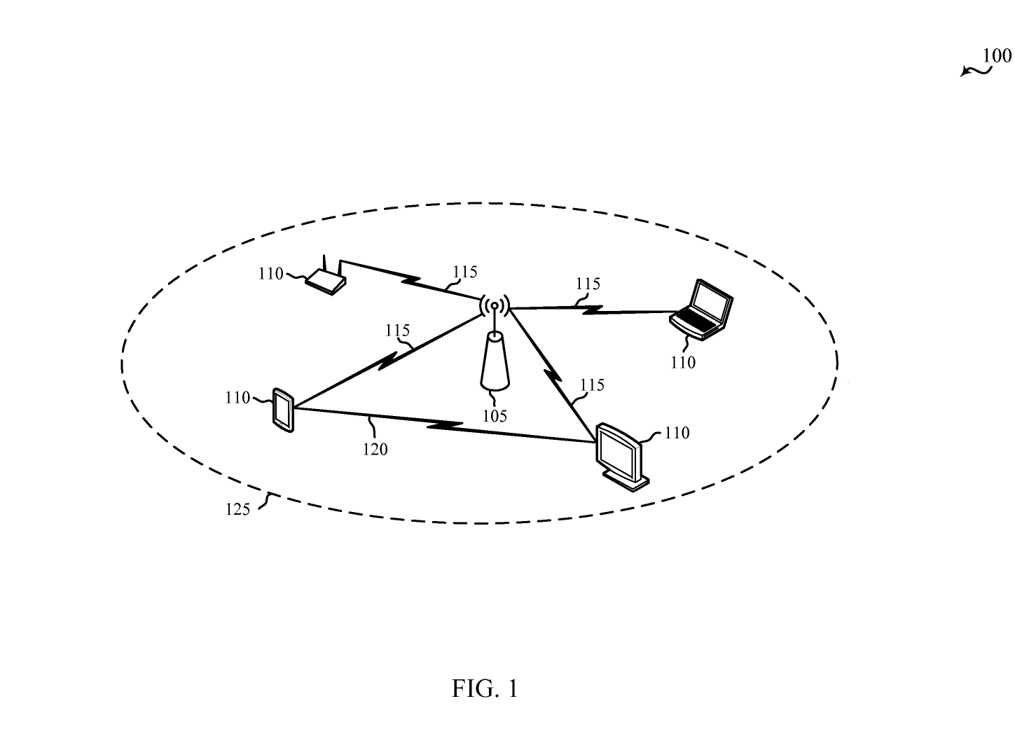

Referring first to FIG. 1, a block diagram illustrates an example of a WLAN or Wi-Fi network 100 such as, e.g., a network implementing at least one of the IEEE 802.11 family of standards. The network 100 may include an access point (AP) 105 and a plurality of wireless devices 110, such as mobile stations, personal digital assistants (PDAs), other handheld devices, netbooks, notebook computers, tablet computers, laptops, display devices (e.g., TVs, computer monitors, etc.), printers, etc. While only one AP 105 is illustrated, the network 100 may have multiple APs 105. Each of the wireless devices 110, which may also be referred to as a client device, wireless station (STA), a mobile station (MS), a mobile device, an access terminal (AT), a user equipment (UE), a subscriber station (SS), or a subscriber unit, may associate and communicate with an AP 105 via a communication link 115. Each AP 105 has a coverage area 125 such that client devices 110 within that area can typically communicate with the AP 105. The client devices 110 may be dispersed throughout the coverage area 125. Each client device 110 may be stationary or mobile.

Although not shown in FIG. 1, a station 110 can be covered by more than one AP 105 and can therefore associate with one or more APs 105 at the same or different times. A single AP 105 and an associated set of stations may be referred to as a basic service set (BSS). An extended service set (ESS) is a set of connected BSSs. A distribution system (DS) (not shown) is used to connect APs 105 in an extended service set. A coverage area 125 for an access point 105 may be divided into sectors making up only a portion of the coverage area (not shown). The network 100 may include APs 105 of different types (e.g., metropolitan area, home network, etc.), with varying sizes of coverage areas and overlapping coverage areas for different technologies. Although not shown, other wireless devices can communicate with the AP 105.

While the devices 110 may communicate with each other through the AP 105 using AP links 115, each device 110 may also communicate directly with at least one other device 110 via a direct wireless link 120. Two or more devices 110 may communicate via a direct wireless link 120 when both devices 110 are in the AP coverage area 125 or when one or neither device 110 is within the AP coverage area 125 (not shown). Examples of direct wireless links 120 may include Wi-Fi Direct connections, connections established by using a Wi-Fi Tunneled Direct Link Setup (TDLS) link, and other P2P group connections. The wireless devices 110 in these examples may communicate according to the WLAN radio and baseband protocol including physical (PHY) and medium access control (MAC) layers from IEEE 802.11, and its various versions including, but not limited to, 802.11b, 802.11g, 802.11a, 802.11n, 802.11ac, 802.11ad, 802.11ah, etc. In other implementations, other peer-to-peer connections and/or ad hoc networks may be implemented in network 100. In some implementations, one or more wireless devices 110 may be elected to be group owners (GOs)/soft APs and may perform some function(s) of an AP 105. In these implementations, a soft AP may be representative of an AP 105.

The communication links 115 shown in the network 100 may include uplink (UL) transmissions from a client device 110 to an AP 105, and/or downlink (DL) transmissions, from an AP 105 to a client device 110. The downlink transmissions may also be called forward link transmissions while the uplink transmissions may also be called reverse link transmissions.

In many scenarios, such as when there is heavy traffic in the network 100, many client devices 110, diversity of data requirements of the client devices 110, etc., communication performance, e.g., throughput, in the network 100 may decrease. In order to increase the communication performance of the network 100 in these and other scenarios, an AP 105 may more dynamically manage traffic in the network 100 by controlling data rates for individual or groups of client devices 110. The AP 105 may first group client devices 110 into at least one group, for example based on data usage of the client devices 110. The AP 105 may then determine a channel characteristic threshold for each group of client devices and control the data rate for each group based on the determined channel characteristic thresholds. In this way, the AP 105 may, for example, dynamically manage traffic in the WLAN, adapt supported data rates to changes in traffic in the WLAN, and support different types of access, priority, and service level requirements in the WLAN.

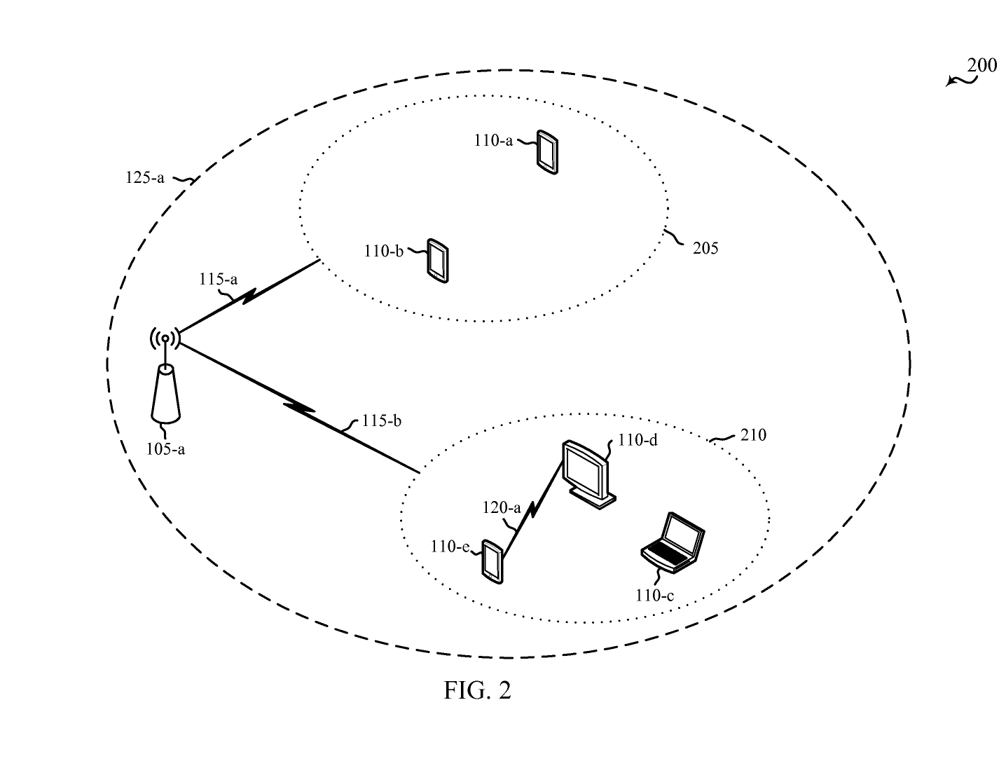

Referring now to FIG. 2, a block diagram illustrates a wireless communications system or network 200 including an AP 105-a and groups 205, 210 of client devices or STAs 110. A first group 205 includes client devices 110-a and 110-b, whereas a second group 210 includes client devices 110-c, 110-d, and 110-e. As illustrated, client devices 110-d and 110-e may communicate with each other via P2P link 120-a. Client devices 110-a, 110-b, and 110-c may be mobile devices or phones, whereas client device 110-c may be a laptop and client device 110-d may be a display device. It should be appreciated that other configurations, types, and groupings of client devices 110 are contemplated herein. The AP 105-a may serve a coverage area 125-a and may communicate on both the uplink and the downlink with the first group 205 via link 115-a and with the second group 210 via link 115-b. The client devices 110-a, 110-b, 110-c, 110-d, 110-e, the AP 105-a, links 115-a, 115-b and 120-a, and/or network coverage area 125-a may be examples of client devices 110, AP 105, links 115 and 120, and/or network coverage area 125 described in reference to FIG. 1. It should be appreciated that wireless communications system or network 200 is given only as an example; other network arrangements, other numbers of client devices 110, other client device groupings, etc., are contemplated herein.

In some aspects, the AP 105-a may acquire or access data usage information of at least one client device 110 in the coverage area 125-a and group the client devices 110 based on the accessed information. The data usage information may include historical information relative to a time of day, including what types of applications are active on the client device 110 at a given time, location of a client device 110, data that a client device 110 communicates/requests on the UL and/or DL 115, etc. In some cases, the information may include priority of access information, such as a type of the client device 110 (e.g., mobile device or phone, tablet, laptop, etc.), a level of priority associated with the client device 110, minimum data requirements of the client device 110, etc. The AP 105-a may gather or access this information and group the client devices 110 and manage traffic in the network 200.

As illustrated in FIG. 2, the AP 105-a may group client devices 110-a, 110-b, and 110-c into the first group 205 and client devices 110-d and 110-e into the second group 210. In one example, the network 200 and/or coverage area 125-a may represent a corporate WLAN. In this scenario, the AP 105-a may group the client devices 110 based on data usage, type of device, location of device, priority of access, or type of access to the network (e.g., wired or wireless link). For example, customers or visitors of the corporate WLAN 200 may be using client devices 110-a and 110-b and may be grouped such that each client device 110-a, 110-b will be supported by a moderate data rate to ensure customer satisfaction, etc. Client devices 110-c, 110-d, and 110-e may be owned/operated by the corporation and may be supported at a peak data rate to provide for maximum productivity.

In another example, network 200 may represent a WLAN in a public shopping area such as a mall. In this and other scenarios, the AP 105-a may group client devices 110 based on whether each client meets the requirements for an optional service, such as for Carrier WiFi (which may provide higher data rates, directed advertising, etc.). When a client device associates with the WLAN 200, the AP 105-a may authenticate whether the client device 110 meets the Carrier WiFi requirements. For instance, in one aspect, the AP 105-a may determine whether the client device is associated with a service provider of the Carrier WiFi service (e.g., whether the cellular service provider of the client device matches the service provider of the Carrier WiFi). This may be performed by verifying the subscriber identification module (SIM) card of the client device 110. In another example, if the client device 110 is not (or has not) previously associated with the service provider of the Carrier WiFi, the AP 105-a may request that the client device 110 accepts terms of service and/or accepts to pay a fee for the service to authenticate the carrier WiFi connection. Upon authentication, the AP 105-a may assign the client device 110 to a Carrier WiFi group, such as the first group 205. If the client device 110 is not authenticated for Carrier WiFi, the client device may be assigned to a non-Carrier WiFi group (e.g., the second group 210).

In another example, network 200 may represent a Wi-Fi network, for instance on a train, bus, airplane or other transportation medium. In this scenario, the AP 105-a may group client devices 110 based on priority of access, such as whether the client device 110 is associated with a first class ticket, a second class ticket, a coach ticket, etc. Priority information may be associated with the client device 110, for example, at the time of ticket purchase by linking user information (e.g., email address, phone number, user name, etc.) associated with the client device 110 to the type of ticket purchased. Priority information may additionally or alternatively be associated with the client device at the time of association with the WiFi network 200, for example by requesting information associated with the ticket in order for the client device 110 to connect to the WiFi network 200.

It should be appreciated that other types of organization schemes are contemplated herein. For example, each group may be associated with or classified by a type of device and a level of priority, data usage and type of access, etc.

In some aspects, the AP 105-a may group client devices 110 based on limited information, such as data usage information for only some of the client devices 110 in the network 200. In other cases, the AP 105-a may gather data usage information or other types of information for all of the client devices 110 in the network to be used for determining how to group the client devices 110.

Upon placing client devices 110 into groups in the network 200, the AP 105-a may then determine at least one channel characteristic threshold for each group and control the data rate for each group based on the channel characteristic threshold(s). For example, the AP 105-a may assign or associate client devices 110-a and 110-b to the first group 205 and control a data rate of the first group 205 by communicating the channel characteristic threshold(s) to the first group 205 via link 115-a. Similarly, the AP 105-a may assign or associate client devices 110-c, 110-d, and 110-e to the second group 210 and control a data rate of the second group 210 by communicating the channel characteristic threshold(s) via link 115-b. The AP 105-a may set channel characteristic thresholds/control the data rate for each group 205, 210 separately for UL and DL communications, respectively. For example, in some cases, DL traffic may be limited based on capabilities of the AP 105-a, while the AP 105-a may not have the same limitations for UL traffic. In this scenario and others, it may be beneficial for the AP 105-a to set different limits on data rates for UL and DL communications with groups 205, 210.

In some cases, the AP 105-a may communicate the channel characteristic threshold(s) to the different groups 205, 210 concurrently or at different times. Additionally, the AP 105-a may assign or associate the client devices 110 to different groups 205, 210 at different times, for example when client devices 110 join and leave the network 200. In some cases, upon a client device 110 joining or leaving the network 200, the AP 105-a may reorganize or reassign the associated client devices to different groups. The reorganization or reassignment of groups may maximize limited network resources, provide increased throughput for certain client devices, or for numerous other reasons.

In some embodiments, the AP 105-a may ignore communications/traffic across direct links 120, such as link 120-a between client devices 110-d and 110-e, when grouping client devices, determining channel characteristic thresholds, and/or controlling data rates for the groups 205, 210 of client devices 110. For example, traffic across link 120-a may not affect DL bandwidth for the AP 105-a. In this scenario, processing time, power, etc., may be reduced without sacrificing communication performance in the network 200 by ignoring traffic on link 120-a, when the AP 105-a is determining available network bandwidth for grouping or determining at least one channel characteristic threshold. In other cases, communications across link 120-a may limit the UL communication capacity of client device 110-d and/or 110-e. By accounting for the traffic across link 120-a, the AP 105-a may allocate UL resources to client devices 110 that may use the entire assigned UL resources.

In some embodiments, the AP 105-a may perform the described techniques in a different order. For example, the AP 105-a may first determine channel characteristic thresholds for the associated client devices 110-a through 110-e of the network 200. The AP 105-a may do so by comparing the data requirements of the client devices 110-a through 110-e and/or associated traffic and data usage information. Upon determining the channel characteristic thresholds, the AP 105-e may then assign client devices to groups 205, 210 based on the determined channel characteristic thresholds. For example, client devices with similar thresholds may be assigned to the same group. In this way, the AP 105-a may be able to divide the available network resources and perform grouping in an integrated manner.

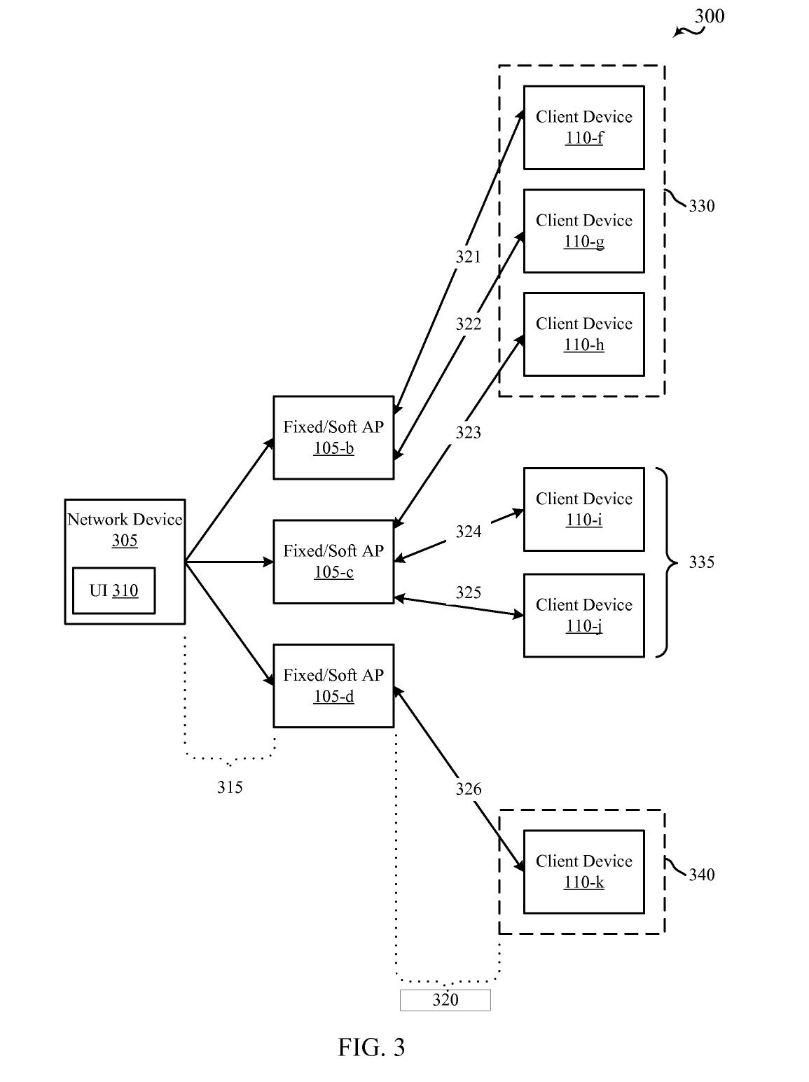

Referring now to FIG. 3, a block diagram illustrates a network 300 including a network device 305 in communication with three fixed/soft APs 105-b, 105-c, and 105-d, which are further in communication with client devices 110-f through 110-k. The network device 305 may include a user interface (UI) 310, such as any input device or separate program or computer program code that may enable a user to control data rates for individual or groups of client devices 110 in the network 300. The network device 305 may be in communication with fixed/soft APs 105-b, 105-c, 105-d via interface 315, which may be a wired interface, a wireless interface, or a combination thereof. AP 105-b may be in communication with client devices 110-f and 110-g of group 330 via links 321 and 322. AP 105-c may be in communication with client device 110-h of group 330 via link 323, and with client devices 110-i and 110-j of default group 335 via links 324 and 325. AP 105-d may be in communication with client device 110-k of group 340 via link 326. Links 321-326 may form interface 320, which may be a wireless interface. The client devices 110-f, 110-g, 110-h, 110-i, 110-j, 110-k, APs 105-b, 105-c, 105-d, links 321-326, and/or groups 330, 335, 340 may be examples of client devices 110, APs 105, links 115, and/or groups 205, 210 described in reference to FIGS. 1 and/or 2. It should be appreciated that network 300 is given only as an example; other network arrangements, client device groupings, etc., are contemplated herein.

In one aspect, a controller of a network (e.g., a WLAN) 300 may use the UI 310 of network device 305, which may be a controller, client device 110, soft/fixed AP 105, etc., to control access and data rates in the network 300. The UI 310 may include any type of input device (e.g., keyboard and mouse, voice control, touchscreen, etc.) and may enable a user or controller of the network 300 to configure and control channel characteristic thresholds, priority schemes, and access to the network 300, etc. In one example, a controller of a corporate WLAN or public WLAN 300 may enter channel characteristic thresholds and/or priority information to control access and data rates supported in the WLAN 300. The UI 310 may also enable a user to control how client devices are grouped, such as based on priority, type of device, data usage patterns, and the like, which may indirectly affect the supported data rate for each client device 110. In another example, network 300 may represent a Wi-Fi network, for instance on a train, bus, airplane or other transportation device, or in other types of spaces. In this scenario, a controller of the Wi-Fi network may enable different data rates for different levels or priorities of customers. For instance, first class passengers on a flight may be entitled to a higher data rate via the first class ticket than second or coach class customers. The UI 310 may enable a controller of the network 300 to configure access in similar or other manners.

The information obtained by the UI 310 may then be communicated to the fixed/soft APs 105-b, 105-c, 105-d via interface 315. The APs 105-b, 105-c, 105-d may then group client devices 110-f through 110-k into groups 330, 335, 340, determine channel characteristics for each group 330, 335, 340, and control data rates for each group 330, 335, 340 using the information communicated from the UI 310, via links 321-326.

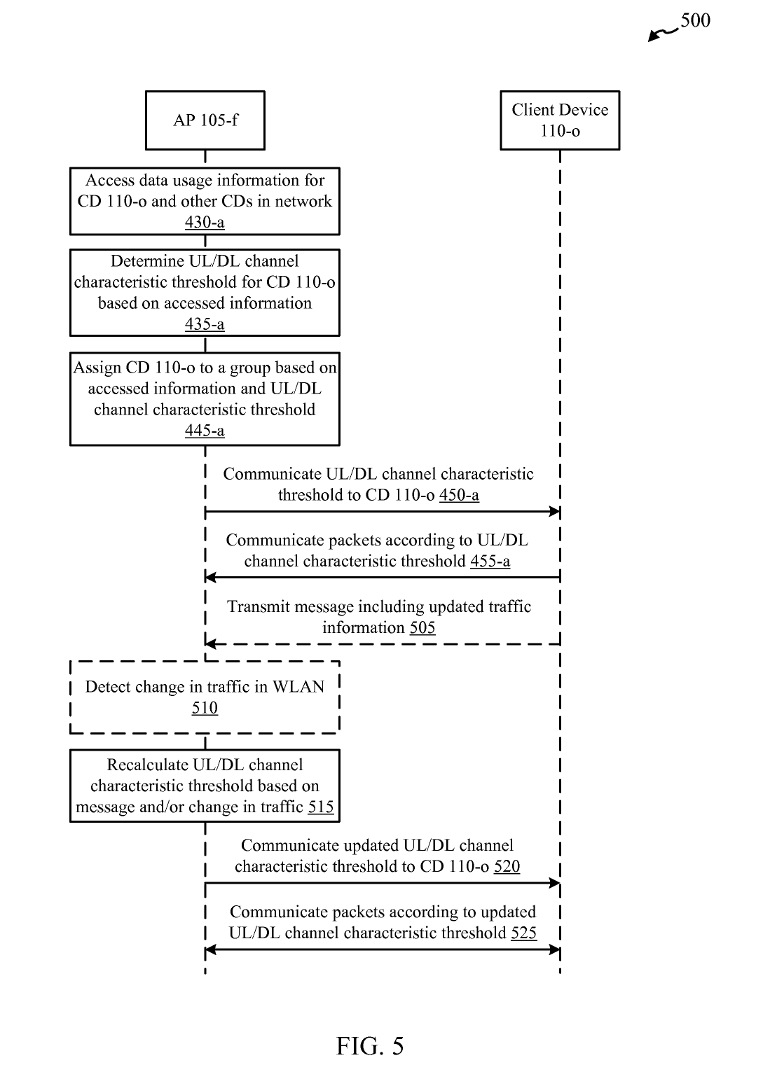

In some cases, for example when a new client device 110 joins network 300, the client device 110 may be temporarily assigned to a default group 335 to support a default data rate. As illustrated, AP 105-c may be in communication with two client devices 110-i, 110-j in the default group 335 via links 324, 325. In some aspects, the default group may support any data rate up to a configured maximum data rate (e.g., 6 Mbps up to 54 Mbps). In some cases, both DL and UL data rates may be configured. To access the network 300, client devices 110-i, 110-j may send a message to AP 105-c. In one example, AP 105-c automatically assigns the client device 110-i, 110-j to the default group 335 and sends channel characteristic threshold(s) (corresponding to the default group) to control the data rate of UL and/or DL communications with client device 110-i, 110-j. AP 105-c may ignore packets received from the client device 110-i, 110-j if the packets are sent at an unsupported data rate. This may occur, for example, if the client device 110-i, 110-j does not receive the channel characteristic threshold(s) (e.g., is unable to decode the message). The AP 105-c may continue to ignore packets sent from the client device 110-i, 110-j until the client device 110-i, 110-j reduces the data rate such that it falls within the supported data rate. This process will be described in greater detail below with reference to FIG. 5.

In some cases, a client device 110-i, 110-j may acknowledge and abide by the default group data rate, such as by successfully receiving at least one channel characteristic threshold and subsequently communicating according to the indicated threshold(s). In this scenario, AP 105-c may then, based on data usage information or other information of the client device 110-i, 110-j and/or other client devices 110 in the network 300, assign the client device 110-i, 110-j to a new or existing group (e.g., groups 335 or 340).

In some aspects, different APs 105-b and 105-c may provide service to client devices (e.g., client devices 110-f, 110-g, and 110-h) in the same group 335. In one example, each APs 105-b, 105-c, 105-d may provide service to separate non-overlapping coverage areas. Each AP 105 may support a bandwidth based on the hardware implemented at the AP 105, software, or other considerations. The APs, 105-b, 105-c, and/or 105-d may cooperate (e.g., via the network device 305 or via backhaul links not shown) with each other to allocate bandwidth resources of each AP 105 to support the client devices 110 in the network 300 at any given time. The APs 105-b, 105-c, and/or 105-d may adapt to changes in the network, such as new client devices 110 joining or leaving the network 300, APs 105 joining or leaving the network, receiving new parameters from the network device 305, etc. The APs 105-b, 105-c, and/or 105-d may do so by regrouping the associated client devices 110 and/or setting new channel characteristic thresholds for at least one group 330, 335, 340.

In another example, each AP 105-b, 105-c, and/or 105-d may operate autonomously to group client devices 110 and control the supported data rates for each group independent of other APs 105. In some examples, a group, such as group 340, may include only one client device 110-k.

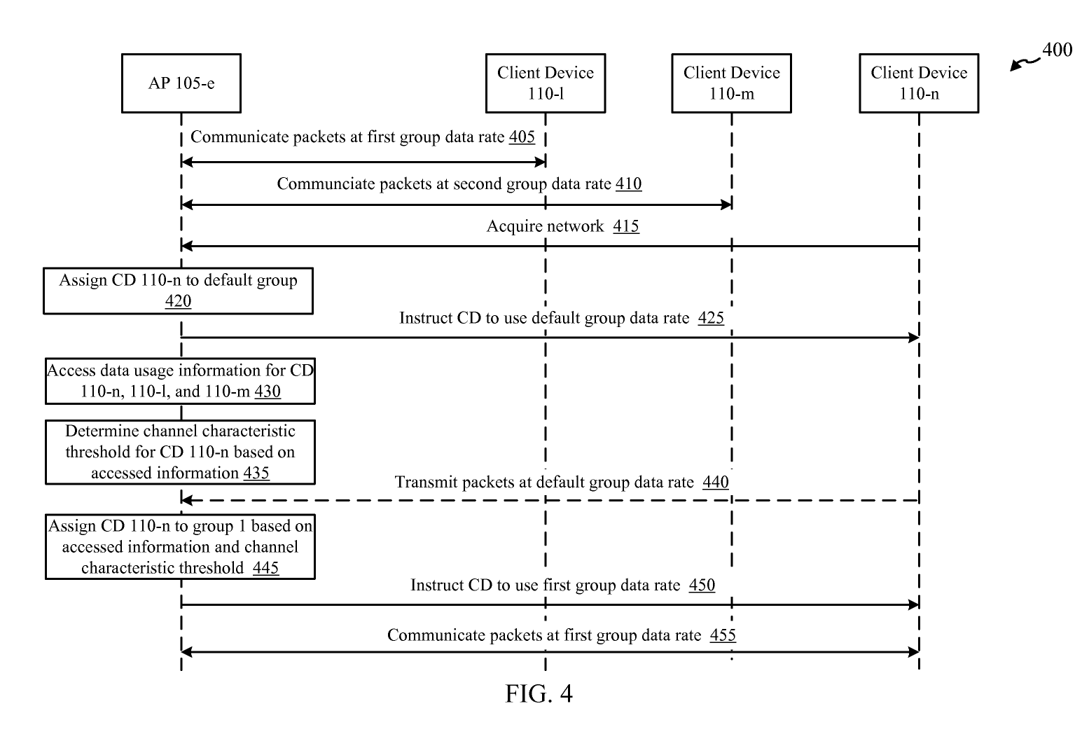

Referring now to FIG. 4, a flow diagram 400 illustrates communications between an AP 105-e and client devices 110-l, 110-m, 110-n in accordance with various embodiments. AP 105-e and/or client devices 110-l, 110-m, 110-n, may be examples of APs 105 and/or client devices 110 described in reference to FIGS. 1, 2, and/or 3. AP 105-e may communicate with client devices 110-l, 110-m, and/or 110-n via communication links 115 or 321-326 as described above in reference to FIGS. 1, 2, and/or 3.

In one example, client device 110-l may be associated with a first group of client devices at a first group data rate. The first group may be any of groups 205, 210, 330, and/or 340 described above in reference to FIGS. 2 and/or 3, and the supported data rate may be according to one or more channel characteristic thresholds assigned and communicated to the first group of client devices. Client device 110-l may communicate packets with the AP 105-e at the first group data rate at 405. Similarly, client device 110-m may be associated with a second group of client devices at a second group data rate, such as any of groups 205, 210, 330, and/or 340 described above in reference to FIGS. 2 and/or 3. Client device 110-m may communicate packets with the AP 105-e at the second group data rate at 410.

Client device 110-n may enter a coverage area (e.g., coverage area 125) of AP 105-e and attempt to acquire the network at 415. The AP 105-e may assign the client device 110-n to a default group at 420. The AP 105-e may then instruct the client device 110-n to use a default group rate for communications with the AP 105-e at 425. The AP 105-e may instruct the client device 110-l to use a default group rate by communicating one or more channel characteristic thresholds to the client device 110-l, such as a minimum bandwidth threshold, a maximum bandwidth threshold, a message size threshold, a throughput threshold, or an optional service requirement (e.g., for carrier Wi-Fi).

AP 105-e may access data usage information for the client device 110-n and/or for the other client devices served by AP 105-e (e.g., client devices 110-l and 110-m) at 430. In some examples, the data usage information may include the amount or type of data communicated by a client device 110 relative to a time of a day or reference clock, information of the applications most frequently used by a client device 110 and the type/amount of data, periodic sleep cycles of a client device 110, and other similar data usage information. In some cases, the AP 105-e may have information of client device data usage stored on a local memory such that the AP 105-e can easily retrieve the information. In some cases, the AP 105-e may access the data usage information via another AP 105 or a network device (e.g., network device 305 of FIG. 3). In yet other cases, the AP 105-e may request the information from at least one client device 110-l, 110-m, 110-n. The AP 105-e may periodically retrieve updated data usage information relative to at least one served client device 110-l, 110-m, 110-n to dynamically manage data flow in the network, for instance when bandwidth resources are limited.

In some cases, when a client device 110-n acquires a connection with the AP 105-e (or periodically), the AP 105-e may access traffic information of the network (not shown). The traffic information may include latency information relative to one or more client devices 110, other delay information, etc.

The AP 105-e may then determine at least one channel characteristic threshold for the client device 110-n based on the accessed data usage information and/or the traffic information at 435 and assign the client device 110-n to the first group based on the information accessed at 430 and the determined channel characteristic threshold(s) at 445. The AP 105-e may then instruct client device 110-n to use the first group data rate, for example, by communicating the determined channel characteristic threshold(s) at 450. The AP 105-e and the client device 110-n may then communicate packets at the first group data rate at 455.

In some cases, the client device 110-n may transmit at least one packet to the AP 105-e at the default group data rate before the client device 110-n is assigned to a the first group, such as at 440. To enable communications with the client device 110-n before assigning it to a more permanent group of client devices, the AP 105-e may set the default group data rate lower than the maximum available bandwidth the network may allow. In particular, the AP 105-e may set the default group data rate low enough to allow multiple devices to join the network concurrently without causing any disruption in service to the other client devices 110-l, 110-m of the network. In other cases, the AP 105-e may set each group data rate to use all the available network bandwidth, such as to maximize communication performance and throughput for all the associated client devices 110-l, 110-m. The AP 105-e may, in this scenario, reorganize the grouping of at least one associated client device when a new client device 110-n joins the network, in order to avoid a significant drop in service for the associated client devices 110-l, 110-m.

The above description in reference to FIG. 4. has implicitly combined both uplink and downlink data rates for ease of explanation. It should be appreciated, as will be described in greater detail below in reference to FIG. 5, that the AP 105-e may control data rates (e.g., by setting channel characteristic thresholds) for UL and/or DL communications with at least one client device 110-l, 110-m, 110-n, for example, to manage network performance, etc.

Referring now to FIG. 5, a flow diagram 500 illustrates communications between an AP 105-f and a client device 110-o, in accordance with various embodiments. AP 105-f and/or client device 110-o may be examples of APs 105 and/or client devices 110 described in reference to FIGS. 1, 2, 3, and/or 4. AP 105-f may communicate with client device 110-o via communication links 115 or 321-326 described above in reference to FIGS. 1, 2, and/or 3.

In one example, client device 110-o may have previously acquired a network connection with AP 105-f and may have been associated with a default group such that the AP 105-e and the client device 110-o may communicate at a default group data rate (not shown). The AP 105-f then may access data usage information (and/or traffic information) for the client device 110-o and in some cases, other client devices 110 in the network served by the AP 105-f at 430-a. The AP 105-f may determine at least one UL and/or DL channel characteristic threshold for the client device 110-o based on the information accessed at 435-a. In one example, the AP 105-f may determine a threshold for one of the UL or DL, and leave the other link unrestricted. In another example, the AP 105-e may determine at least one threshold for each of the UL and DL. The AP 105-f may decide whether to implement an UL or DL threshold based on, for example, congestion/traffic in the network, priority or other access schemes, minimum or maximum data rate requirements of any of the client devices 110 associated with the network, etc.

The AP 105-f may then assign the client device 110-o to a group based on the accessed information and the determined UL/DL channel characteristic thresholds at 445-a. The AP 105-f may communicate the UL/DL channel characteristic thresholds to the client device 110-o at 450-a and the AP 105-f and the client device 110-o may then communicate packets according to the UL/DL channel characteristic thresholds at 455-a.

In one example, the client device 110-o may transmit a message including updated traffic information to the AP 105-f at 505. In some cases, the updated traffic information may include data usage pattern information, or type of client device, or priority of access, for at least one of the plurality of client devices in the at least one group. In some cases, the traffic information may relate to changes in latency or latency requirements of the client device 110-o, delays experienced by the client device 110-o, or information relative to traffic of other client devices, etc. In some cases, the AP 105-f may detect updated traffic information relative to the client device 110-o without receiving a message from the client device 110-o (e.g., by detecting a change in communications with the client device 110-o).

In another example, the AP 105-f may detect a change in traffic in the network, for instance including a client device joining or leaving the network at 510. In other cases, the AP 105-f may detect an AP 105 joining or leaving the network. In yet some cases, the AP 105-e may detect a change in data usage of at least one client device 110.

Upon receiving updated traffic information and/or detecting a change in traffic in the network, the AP 105-f may recalculate the UL/DL channel characteristic thresholds for the client device 110-o at 515. In some cases, the AP 105-e may recalculate other UL/DL channel characteristic thresholds for other associated client devices 110. The AP 105-e may then communicate the updated UL/DL channel characteristic thresholds to the client device 110-o at 520, and may communicate with the client device 110-o according to the updated channel characteristic thresholds at 525.

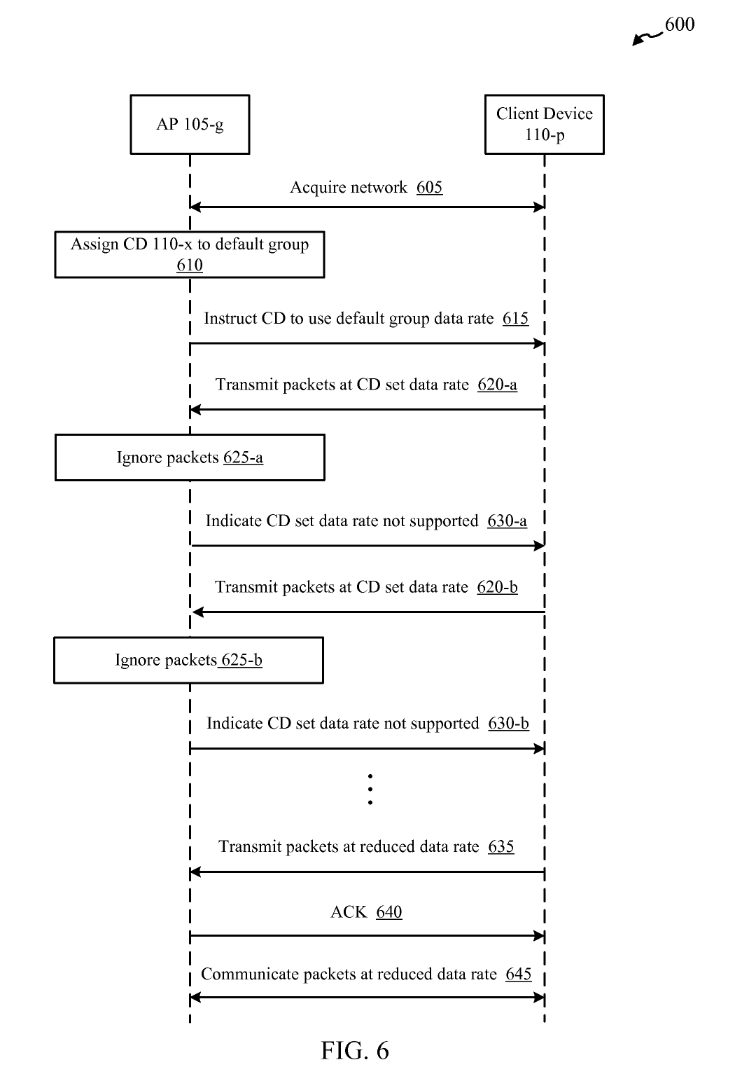

Referring now to FIG. 6 a flow diagram 600 illustrates communications between an AP 105-g and a client device 110-p, in accordance with various embodiments. AP 105-g and/or client device 110-p may be examples of APs 105 and/or client devices 110 described in reference to FIGS. 1, 2, 3, 4, and/or 5. AP 105-g may communicate with client device 110-p via communication links 115 or 321-326 described above in reference to FIGS. 1, 2, and/or 3.

In one example, client device 110-p may attempt to acquire the network at 605. Upon receiving messaging from the client device 110-p, the AP 105-g may assign the client device 110-p to a default group at 610 and instruct the client device 110-p to use a data rate associated with the default group at 615 (e.g., by communicating at least one channel characteristic threshold to the client device 110-p).

In some cases, the client device 110-p may not be able to read or decode the message sent from the AP 105-g instructing the client device 110-p to use the default group data rate. In this scenario, the client device 110-p may continue to transmit packets to the AP 105-g at a data rate determined by the client device 110-p at 620-a. In response, particularly if the data rate set by the client device 110-p is greater than the default group data rate, the AP 105-p may ignore packets transmitted by the client device 110-p at 625-a. The AP 105-g may indicate to the client device 110-p that the data rate is not supported at 630-a. In the event the client device 110-p fails to decode the indication sent at 630-a, the client device 110-p may transmit new (or retransmit prior) packets at the same data rate at 620-b. The AP 105-g may ignore the packets at 625-b and may again indicate to the client device 110-p that the data rate is not supported at 630-b. This may continue (e.g., steps 620, 625, and 630 may repeat), until the client device 110-p, after any number of failed attempts to communicate with the AP 105-g, transmits packets to the AP 105-g at a reduced data rate at 635. If the reduced data rate is equal to or less than the default group data rate, then the AP 105-g may acknowledge the packets at 640, and the AP 105-g and the client device 110-p may communicate packets at the reduced data rate at 645. However, if the AP 105-g does not support the reduced data rate (not shown), the AP 105-g may continue to ignore the packets, indicate that the data rate is not supported, and so on until the client device 110-p transmits at a data rate that is supported by the AP 105-g.

In this way, the described techniques may be backwards compatible. In particular, APs 105 may communicate with and control data rates in a network including client devices 110 that do not support particular data rate control messaging. Accordingly, the described techniques may be implemented in a variety of communications systems supporting legacy and other communication systems.

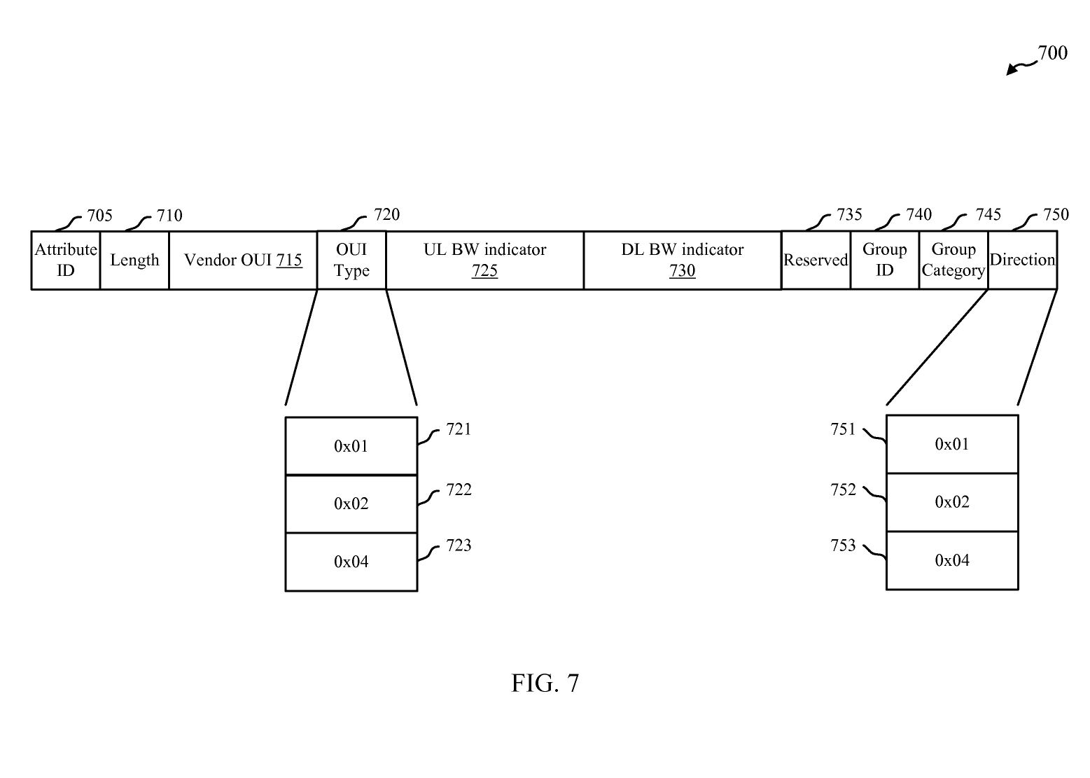

Referring now to FIG. 7, a block diagram of an Information Element (IE) 700 that may be used to communicate at least one channel characteristic threshold/control the data rate of a client device 110 is shown. IE 700 may include various fields, such as Attribute ID field 705, Length field 710, Vendor Organizationally Unique Identifier (OUI) 715, OUI Type field 720 (also referred to as an threshold application indication), UL Bandwidth (BW) Indicator field 725, DL BW Indicator field 730, a Reserved field 735, Group ID field 740, Group Category field 745, and/or Direction field 750. The IE 700 may be used by an AP 105 to communicate data rate and/or channel characteristic thresholds to a client device 110, such as over links 115, 321-326 described in reference to FIGS. 1, 2, and/or 3, and/or via messaging 425, 450, 520, 615, and/or 630 described in reference to FIGS. 4, 5, and/or 6. The IE 700 is described only as an example of a message for indicating data rate and/or channel characteristic threshold information; it should be appreciated that any other type of messaging may be used and is contemplated herein.

In one aspect, the Attribute ID field 705 of IE 700 may indicate a type of the message (e.g., a vendor extension) and may be one octet in length. The Length field 710 may similarly be one octet in length and may indicate the length of the remaining fields of IE 700, for example with the value “0×08.” The OUI Type field 720 may be three octets in length and may indicate a vendor associated with the IE 700.

The OUI Type field 720 (or threshold application indication) may indicate the network bandwidth and may be one octet in length. In particular, a value of “0×01” 721 in the OUI type field 720 may indicate that bandwidth in the network is unrestricted. As a result, bandwidth limitations will not be applied when transferring data on the present connection. A value of “0×02” 722 in the OUI Type field 720 may indicate that the network bandwidth is fixed, such that data transfer is restricted in the network and the limits against a maximum data rate are to be applied. A value of “0×04” 723 in the OUI type field 720 may indicate that network bandwidth is variable, such that the network can support (e.g., enable) the maximum data rates supported by the client device 110.

The UL BW Indicator field 725 and the DL BW Indicator field 730 may each be four octets in length and may indicate bandwidth limitations for the UL and DL respectively. As described above in reference to previous Figures, channel characteristic threshold(s)/data rates may be indicated in the IE 700 by the UL and DL BW Indicator fields 725, 730.

The Group ID field 740 may indicate a particular group the receiving client device 110 is associated with and may be one octet in length. The value of the Group ID field may be set for the network by the transmitting AP 105 or other network device controlling access/data rates in the network (e.g., network device 305 of FIG. 3). The Group Category field 745 may indicate what type of group the receiving client device 110 is associated with, such as the primary group (e.g., a first class passenger on a plane), a secondary group, a guest group (e.g., associated with temporary or restricted access), or a default group (e.g., when the client device joins a network). The Group Category field 745 may be one octet in length. Additionally or alternatively, the Group Category field 745 may indicate other types of groups.

The Direction field 750 may indicate which of the UL or DL BW indicator fields 725, 730, is to be applied by the receiving client device 110. In particular, a value of “0×01” 751 in the Direction field 750 may indicate that only restrictions on UL communications are to be applied, such that only the UL BW Indicator field 725 is applicable to the receiving client device 110. A value of “0×02” 752 in the Direction Field 750 may indicate that only restrictions on DL communications are to be applied, such that only the DL BW Indicator field 730 is applicable to the receiving client device 110. A value of “0×04” 753 in the Direction Field 750 may indicate that restrictions on both UL and DL communications are to be applied, such that both the UL BW Indicator field 725 and the DL BW Indicator field 730 are to be followed by the receiving client device 110.

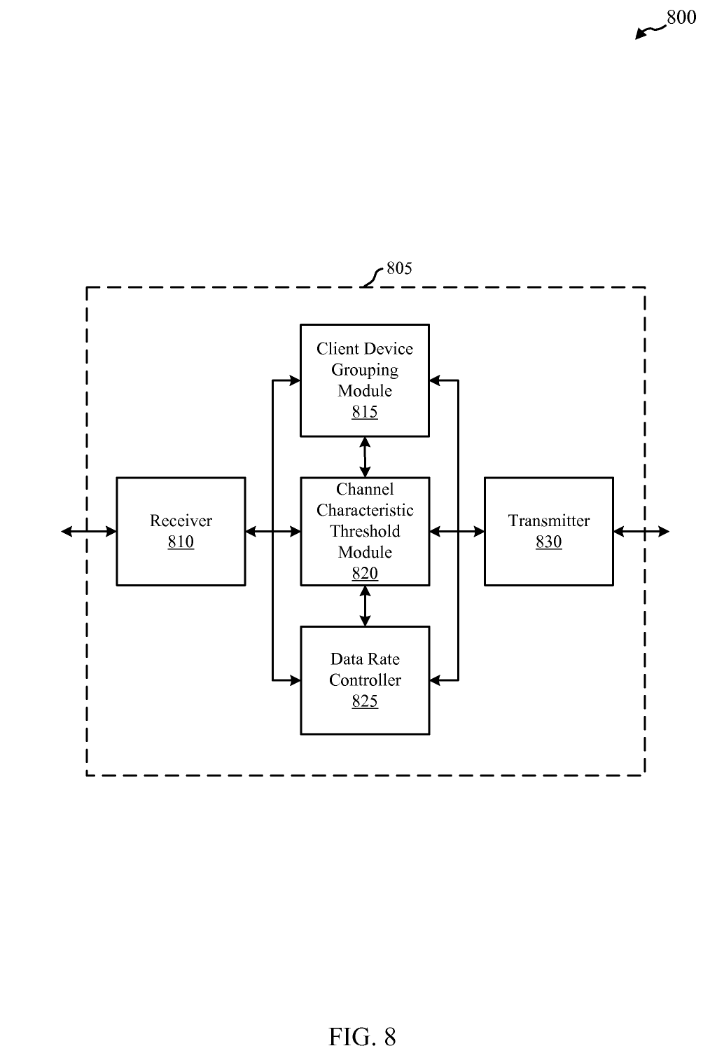

FIG. 8 shows a block diagram 800 of a device 805 configured for controlling data rate(s) for individual or groups of client devices 110 based on at least one channel characteristic threshold, in accordance with various embodiments described herein. The device 805 may be an example of at least one aspect of APs 105, client devices 110 (acting as a soft AP), and/or network devices 305 described above with reference to previous Figures. The device 805 may communicate with at least one client device 110 via communication links 115, and/or links 321-326 as described above in reference to FIGS. 1, 2, and/or 3. The device 805 may communicate with a client device 110 according to flow diagrams 400, 500, and/or 600, and/or using IE 700 described above in reference to FIGS. 4, 5, 6, and/or 7. The device 805 may include a receiver 810, a client device grouping module 815, a channel characteristic threshold module 820, a data rate controller 825, and/or a transmitter 830. Each of these components may be in communication with each other.

The components of the device 805 may, individually or collectively, be implemented using at least one application-specific integrated circuit (ASICs) adapted to perform some or all of the applicable functions in hardware. Alternatively, the functions may be performed by at least one other processing unit (or core), on at least one integrated circuit. In other examples, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by at least one general or application-specific processor.

The receiver 810 may receive information such as packet, data, and/or signaling information regarding what the device 805 has received or transmitted. The received information may be utilized by the device 805 for a variety of purposes. In some cases, the receiver 810 may receive data or transmissions, for example from client devices 110, network devices 305, and/or APs 105, to further enable the various techniques described above for controlling data rates of individual or groups of client devices 110.

The transmitter 830 may transmit information such as packet, data, and/or signaling information from the device 805. In some cases, the transmitter 830 may transmit data to client devices 110, network devices 305, and/or APs 105, to further enable the various techniques described above for controlling data rates of individual or groups of client devices 110.

In one aspect, the receiver 810 may receive communication(s) from a client device 110 seeking to establish a connection with the device 805. The receiver may indicate to the client device grouping module 815, the channel characteristic threshold module 820, and/or the data rate controller 825 that a new client device 110 is attempting to establish a connection with the device 805. The client device grouping module 815 may automatically assign the new client device 110 to a default group. In some cases, the default group may include other devices attempting to access the network or coverage area served by the device 805, client devices 110 that do not support data rate control, etc. The client device grouping module 815 may communicate the assigned group to the channel characteristic threshold module 820 and the data rate controller 825.

The channel characteristic threshold module 820 may then determine at least one threshold, such as at least one bandwidth threshold, a message size threshold, a throughput threshold, etc., associated with the default group. In some cases, the thresholds may be applied to one or both of UL and DL communications with the client device 110. In some cases, the channel characteristic threshold(s) for the default group may be predetermined or preset by the device 805 upon powering up, or may be dynamically configured and adapted based on conditions of traffic received and transmitted by the device 805 via receiver 810 and transmitter 830. The channel characteristic threshold module 820 may communicate the at least one threshold to the data rate controller 825.

The data rate controller 825 may then use information of the group assigned to the client device 110 from the client device grouping module 815 and the at least one determined channel characteristic threshold from the channel characteristic threshold module 820 to configure a message to send to the client device to control a data rate of the client device 110. In some cases, the data rate controller 825 may configure an IE, such as IE 700 described in reference to FIG. 7, to communicate the at least one channel characteristic threshold to the client device 110 and hence control the data rate of the new client device in the default group. The data rate controller 825 may then communicate the message or IE to the transmitter to be transmitted to the client device 110.

In some cases, upon the new client device associating with the device 805, the thresholds for the default group may be reconfigured, such as to equally distribute bandwidth resources among the client devices 110 associated with the default group. In other cases, the default group thresholds may remain unchanged upon association by the new client device 110.

The client device grouping module 815 may access data usage information for the new client device 110 after the new client device has been assigned to the default group to assign the new client device 110 to another group besides the default group (e.g., such as a group that potentially supports a higher data rate, based on priority information, client device type information, etc.). The client device grouping module 815 may also access data usage information of other client devices 110 associated with the device 805 and/or traffic information of the network or coverage are served by the device 805. In some cases, data usage information may be stored locally on the device 805. In other cases, the device 805 may retrieve the data usage information from other devices, such as a network devices 305, APs 105, or client devices 110. Based on the accessed information, the client device grouping module 815 may reassign the new client device 110 to a different group (e.g., a primary or secondary group), that may support a higher data rate and/or may be unrestricted for UL and/or DL communications, etc.

The client device grouping module 815 may communicate the new group assignment, and in some cases the accessed information, to the channel characteristic threshold module 820 and the data rate controller 825. As similarly described above, the channel characteristic threshold module 820 may determine at least one threshold for the new client device 110 based on the group assignment and the accessed information and communicate the thresholds to the data rate controller 825. The data rate controller 825, using the thresholds and accessed information, may then configure a message (e.g., the IE 700 of FIG. 7) to communicate the thresholds to the new client device 110 and to control a data rate of the new client device 110 according to the updated group assignment. The data rate controller 825 may communicate the message (IE) to the transmitter to be transmitted to the newly associated client device 110.

In this way, the device 805 may initially group a newly associated client device 110 into a default group defined by a first set of channel characteristic thresholds. The device 805 may then reassign the client device 110 to a new group based on data usage information of the client device 110 (and in some cases information of traffic in the network and of other client devices 110 associated with the device 805). By these techniques, the device 805 may more adaptively and dynamically manage traffic in a network or coverage area of the device 805 by controlling data rates of individual or groups of client devices 110.

In some embodiments, the device 805 may immediately place the newly associating client device 110 into a group based on priority information, data rate requirements, type of the client device 110, etc., without first assigning the client device 110 to a default group. This may be beneficial, for example when the network and/or device 805 his not bandwidth limited, or to provide a higher level of service, etc.

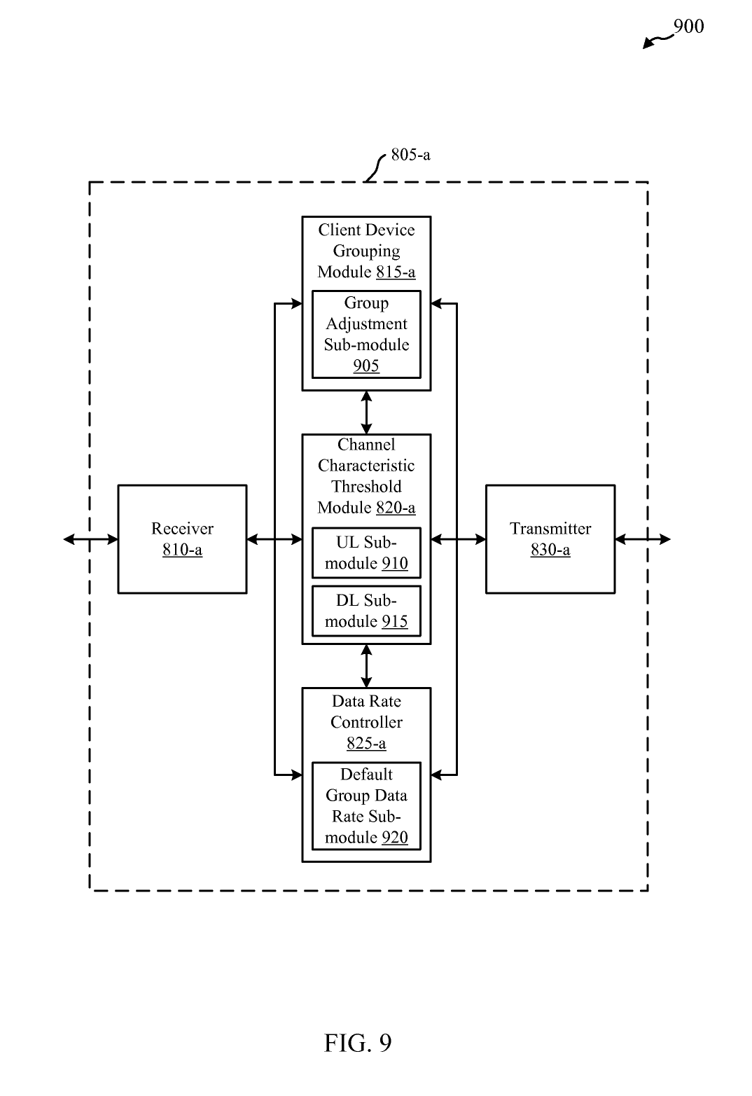

FIG. 9 shows a block diagram 900 of a device 805-a configured for controlling data rate(s) for individual or groups of client devices 110 based on at least one channel characteristic threshold, in accordance with various embodiments described herein. The device 805-a may be an example of at least one aspect of APs 105, client devices 110 (acting as a soft AP), network devices 305, and/or device 805 described above with reference to previous Figures. The device 805-a may communicate with at least one client device 110 via communication links 115 and/or links 321-326 as described above in reference to FIGS. 1, 2, and/or 3. The device 805-a may communicate with a client device 110 according to flow diagrams 400, 500, and/or 600, and/or using IE 700 described above in reference to FIGS. 4, 5, 6, and/or 7. The device 805-a may include a receiver 810-a, a client device grouping module 815-a including a group adjustment sub-module 905, a channel characteristic threshold module 820 including an UL and a DL sub-module 910, 915, a data rate controller 825-a including a default group data rate sub-module 920, and/or a transmitter 830-a. Each of these components may be in communication with each other.

The components of the device 805-a may, individually or collectively, be implemented using at least one application-specific integrated circuit (ASICs) adapted to perform some or all of the applicable functions in hardware. Alternatively, the functions may be performed by at least one other processing unit (or core), on at least one integrated circuit. In other examples, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by at least one general or application-specific processor.

The receiver 810-a and transmitter 830-a may incorporate some or all aspects of the receiver 810 and transmitter 830 described above in reference to FIG. 8, and so for the sake of brevity, will not be individually described here.

In one example, the receiver 810-a may receive updated data usage information from at least one client device 110 associated with the device 805-a. The receiver 810-a may communicate the updated data usage information to the client device grouping module 815-a. Additionally or alternatively, the receiver 810-a or other aspect of device 805-a may detect a change in traffic with associated client devices 110, new devices (e.g., client devices 110 or APs 105) joining or leaving the network of the device 805-a, etc., and may communicate this information to the client device grouping module 815-a.

In one aspect, the updated information may pertain to a new client device 110 associating with the device 805-a. In this scenario, the client device grouping module 815-a may assign the new client device 110 to a default group, the channel characteristic threshold module 820-a may determine at least one channel characteristic threshold for the device based on the default group, and communicate the threshold(s) to the data rate controller 825-a. The data rate controller 825-a may then configure a message (e.g., the IE 700 of FIG. 700) to control the data rate of the new client device 110 and communicate the message to the transmitter 830-a to be transmitted to the new client device 110, as described above in reference to FIG. 8.

In some aspects, once the receiver 810-a detects that a new client device 110 is attempting to associate with device 805-a, the reliever may communicate this information directly to the data rate controller 825-a. The default group data rate sub-module 920 of the data rate controller 825-a may then retrieve or access a message or IE to transmit to the new client device 110 with at least one channel characteristic threshold associated with the default group already configured. In this scenario, the client device grouping module 815-a, the channel characteristic threshold module 820-a, and/or the default group data rate sub-module 920 may periodically update the channel characteristic thresholds associated with the default group, for example based on updated traffic or data usage information of the network and/or client devices 110 in the network. Based on the periodically updated channel characteristic thresholds, a standardized message or IE may be configured and stored in the default group data rate sub-module 920. In this way, processing time, power consumption, etc., may be reduced when a new device associates with the device 805-a, by not requiring thresholds to be determined or verified and/or a new IE configured.

In another aspect, information received by the receiver 810-a may pertain to one or more client devices 110 already assigned to a group. In this scenario, the receiver may communicate the information to the group adjustment sub-module 905 of the client device grouping module 815-a. The group adjustment sub-module 905 may then use the updated information to assign at least one associated client device 110 to a different group. The group adjustment sub-module 905 may then communicate the updated group assignments to the channel characteristic threshold module 820-a. The UL sub-module 910 and the DL sub-module 915 of the channel characteristic threshold module 820-a may then determine new UL and DL thresholds, respectively, for at least one of the associated client devices 110. This may include determining new thresholds for client device(s) 110 reassigned to different groups, reconfiguring at least one group threshold to accommodate the changes in traffic and/or data usage, etc. The channel characteristic threshold module 820-a and/or the UL and DL sub-modules 910, 915 may communicate the updated threshold information to the data rate controller 825-a. The data rate controller 825-a may then configure a message (e.g., IE 700 of FIG. 7) to send to each of the affected client devices 110 and may communicate the each message to the transmitter 830-a to be transmitted.

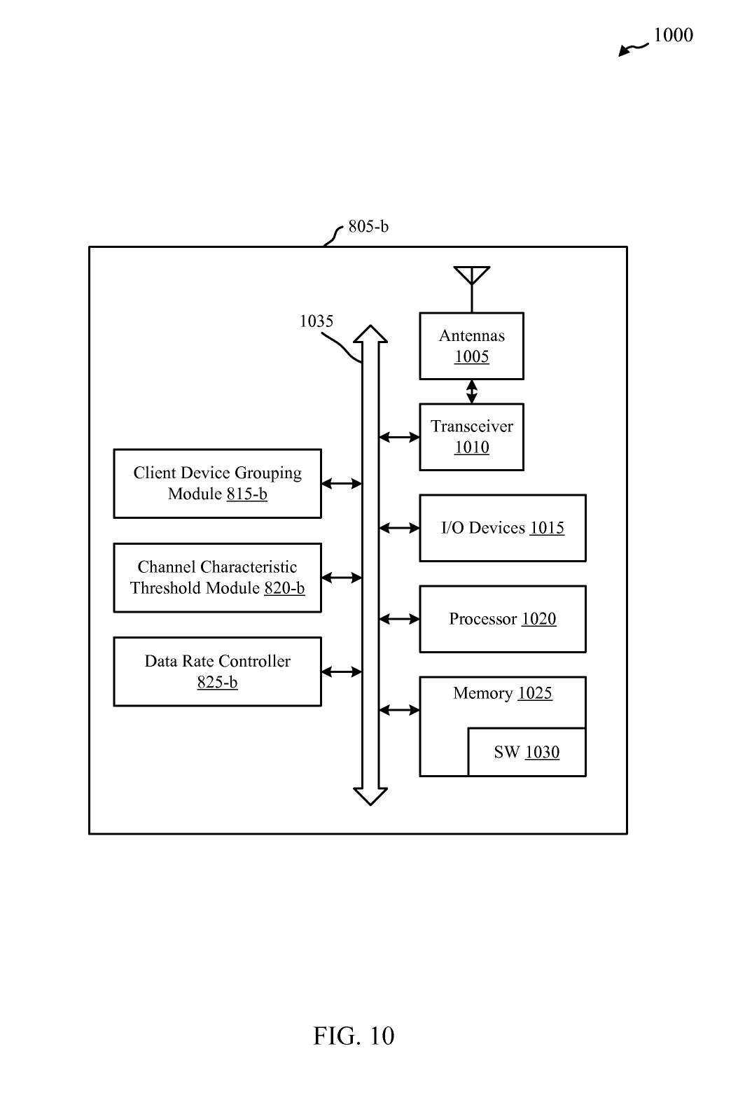

FIG. 10 is a block diagram 1000 of a device 805-b configured for controlling data rate(s) for individual or groups of client devices 110 based on at least one channel characteristic threshold, in accordance with various embodiments described herein. The device 805-b may be an example of at least one aspect of APs 105, client devices 110 (acting as a soft AP), network devices 305, and/or device 805 described above with reference to previous Figures. The device 805-b may communicate with at least one client device 110 via communication links 115 and/or links 321-326 as described above in reference to FIGS. 1, 2, and/or 3. The device 805-b may communicate with a client device 110 according to flow diagrams 400, 500, and/or 600, and/or using IE 700 described above in reference to FIGS. 4, 5, 6, and/or 7. The device 805-b may have any of various configurations, such as personal computers (e.g., laptop computers, netbook computers, tablet computers, etc.), smartphones, cellular telephones, PDAs, wearable computing devices, internet appliances, routers, etc. The device 805-b may have an internal power supply (not shown), such as a small battery, to facilitate mobile operation or may be powered by an external fixed power source.

The components of the device 805-b may, individually or collectively, be implemented using at least one application-specific integrated circuit (ASIC) adapted to perform some or all of the applicable functions in hardware. Alternatively, the functions may be performed by at least one other processing unit (or core), on at least one integrated circuit. In other examples, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by at least one general or application-specific processor.

The device 805-b includes antenna(s) 1005, transceiver(s) 10, memory 1025, a processor 1020, and I/O devices 1015, which each may be in communication, directly or indirectly, with each other, for example, via at least one bus 1035. The transceiver(s) 1010 may communicate bi-directionally, via the antennas 1005 with at least one wired or wireless link, such as any of communication links 115 and/or 321-326 or via interface 315 described above in reference to FIGS. 1, 2, and/or 3. The transceiver(s) 1010 may include a modem to modulate the packets and provide the modulated packets to the antennas 1005 for transmission, and to demodulate packets received from the antennas 1005. The transceiver(s) 1010 may, in conjunction with the antennas 1005, transmit and receive packets. The transceiver(s) 1010 may maintain multiple concurrent communication links using the same or different radio interfaces (e.g., Wi-Fi, cellular, etc.). The device 805-b may include a single antenna 1005, or the device 805-b may include multiple antennas 1005. In some cases, the device 805-b may be capable of employing multiple antennas 1005 for transmitting and receiving communications in a multiple-input multiple-output (MIMO) communication system.

The memory 1025 may include random access memory (RAM) and read-only memory (ROM). The memory 1025 may store computer-readable, computer-executable software 1030 containing instructions that, when executed, cause the processor 1020 to perform various functions described herein. Alternatively, the software 1030 may not be directly executable by the processor 1020 but may cause the computer (e.g., when compiled and executed) to perform functions described herein. The processor 1020 may include an intelligent hardware device, e.g., a central processing unit (CPU), a microcontroller, an application specific integrated circuit (ASIC), etc.

According to the architecture of FIG. 10, the device 805-b may further include a client device grouping module 815-b, a channel characteristic threshold module 820-b, and a data rate controller 825-b. By way of example, these components of the device 805-b may be in communication with some or all of the other components of the device 805-b via bus 1035. Additionally or alternatively, functionality of these modules may be implemented via the transceiver 1010, as a computer program product stored in software 1030, and/or as at least one controller element of the processor 1020. In some embodiments, the client device grouping module 815-b, the channel characteristic threshold module 820-b, and/or the data rate controller 825-b may be implemented as subroutines in memory 1025/software 1030, executed by the processor 1020. In other cases, these modules may be implemented as sub-modules in the processor 1020 itself.

In some aspects, the antenna(s) 1005 and/or transceiver(s) 1010 may receive a message from a client device 110 (e.g., indicating the client device 110 is attempting to associate with the device 805-b, new data usage or traffic information, etc.). This information may be communicated to the client device grouping module 815-b via bus 1035. The client device grouping module 815-b may group client devices 110 (either associating for the first time or based on new data usage information, etc.) into one or more groups. The client device grouping module 815-b may access grouping information (e.g., which client devices 110 are associated with which groups) stored in the memory 1025 to group and/or regroup client devices 110. The channel characteristic threshold module 820-b may determine at least one channel characteristic threshold (UL, DL, or both) based on grouping information communicated from the client device grouping module 815-b. The channel characteristic threshold module 820-b may additionally or alternatively access threshold information associated with a group from the memory 1025. The data rate controller 825-b, based on the channel characters threshold information, grouping information, and/or historic information accessed from memory 1030, may configure a message (IE) for transmitting to a client device 110 for controlling a data rate of the client device 110 according to an associated group. The data rate controller 825-b may then communicate the message to the transceiver(s) 1010 and antenna(s) 1005 to be communicated to the client device 110.

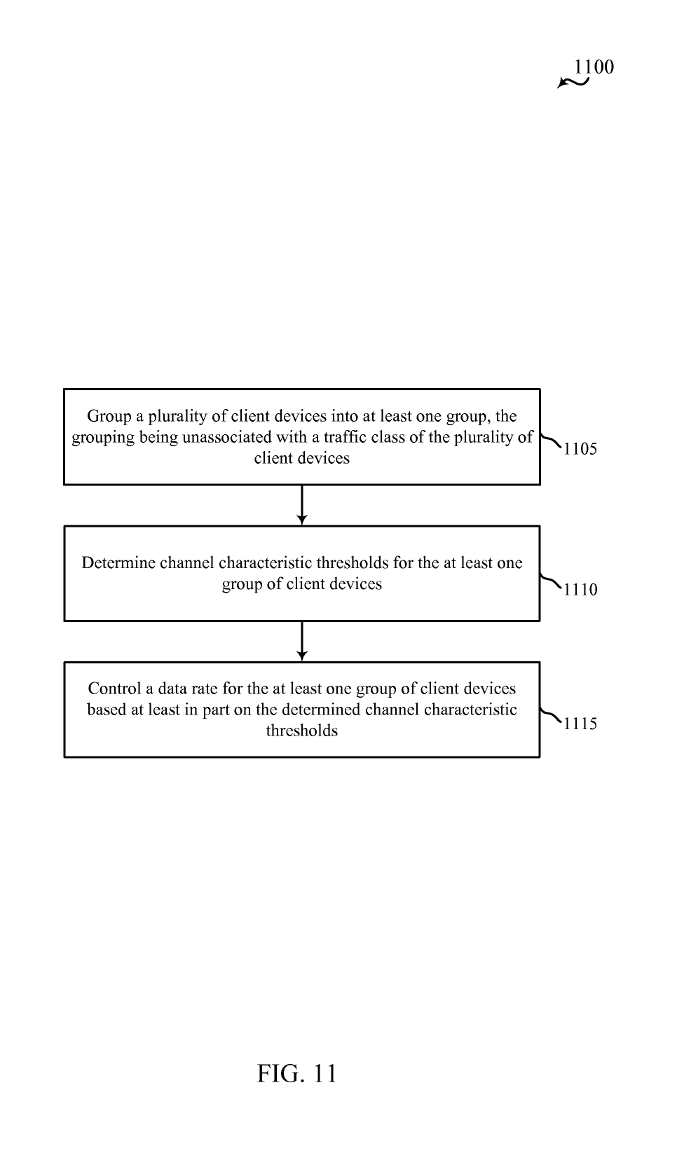

FIG. 11 is a flow chart illustrating one example of a method 1100 for controlling data rate(s) for groups of client devices 110 based on at least one channel characteristic threshold, in accordance with various embodiments described herein. For clarity, the method 1100 is described below with reference to at least one aspect of an AP 105, client device 110 (acting as a soft AP), network device 305, and/or device 805 described with reference to previous Figures. In some embodiments, a device, such as one of the devices 805 or APs 105, may execute at least one set of codes to control the functional elements of the device to perform the functions described below.

At block 1105, a device 805 may group a plurality of client devices 110 into at least one group, the grouping being unassociated with a traffic class of the plurality of client devices 110. In some cases the at least one group of client devices may correspond to group 205, 210, 330, 340, or 345 described above with reference to FIGS. 2 and/or 3. The operation(s) at block 1105 may in some cases be performed using the client device grouping module 815 described with reference to FIGS. 8, 9, and/or 10.

At block 1110, the device 805 may determine channel characteristic thresholds for the at least one group of client devices. The operation(s) at block 1110 may in some cases be performed using the channel characteristic threshold module 820 described with reference to FIGS. 8, 9, and/or 10.

At block 1115, the device 805 may control a data rate for the at least one group of client devices based at least in part on the determined channel characteristic thresholds. The operation(s) at block 1115 may in some cases be performed using the data rate controller 825 described with reference to FIGS. 8, 9, and/or 10.

Thus, the method 1100 may provide for controlling data rates of groups of client devices 110, the grouping being unassociated with a traffic class of the plurality of client devices 110. It should be noted that the method 1100 is just one implementation and that the operations of the method 1100 may be rearranged or otherwise modified such that other implementations are possible.

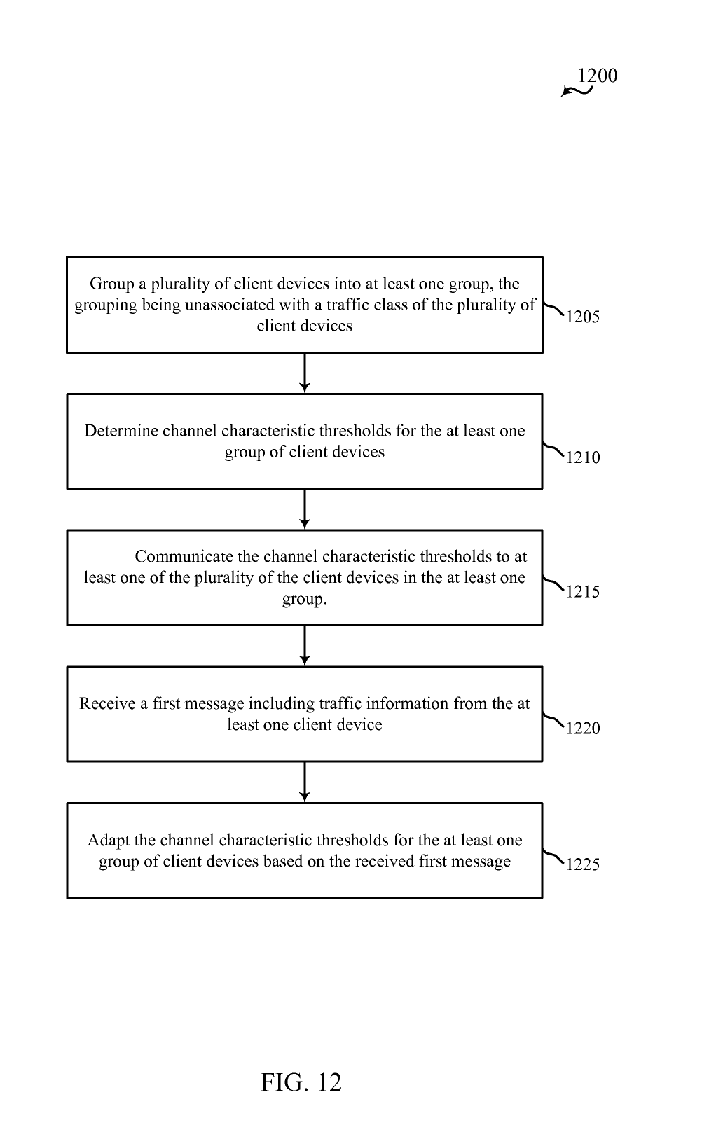

FIG. 12 is a flow chart illustrating another example of a method 1200 for controlling data rate(s) for groups of client devices 110 based on at least one channel characteristic threshold, in accordance with various embodiments described herein. For clarity, the method 1200 is described below with reference to at least one aspect of an AP 105, client device 110 (acting as a soft AP), network device 305, and/or device 805 described with reference to previous Figures. In some embodiments, a device, such as one of the devices 805 or APs 105, may execute at least one set of codes to control the functional elements of the device to perform the functions described below.

At block 1205, a device 805 may group a plurality of client devices 110 into at least one group (e.g., groups 205, 210, 330, 335, and/or 340 of FIGS. 2 and/or 3), the grouping of the plurality of client devices being unassociated with a traffic class of the plurality of client devices 110. The operation(s) at block 1205 may in some cases be performed using the client device grouping module 815 described with reference to FIGS. 8, 9, and/or 10.

At block 1210, the device 805 may determine channel characteristic thresholds for the at least one group of client devices. The operation(s) at block 1210 may in some cases be performed using the channel characteristic threshold module 820 described with reference to FIGS. 8, 9, and/or 10.

At block 1215, the device 805 may communicate the channel characteristic thresholds to at least one of the plurality of the client devices 110 in the at least one group. The operation(s) at block 1215 may in some cases be performed using the data rate controller 825 in conjunction with the transmitter 830 or antenna(s) 1005 and transceiver(s) 1010 described with reference to FIGS. 8, 9, and/or 10. In some cases, the channel characteristic thresholds may be communicated in an IE 700 described in reference to FIG. 7.

At block 1220, the device 805 may receive a first message including traffic information from the at least one client device 110. The first message may include new or updated data usage information associated with the client device 110, traffic information, etc. The operation(s) at block 1220 may in some cases be performed using the receiver 810 or antenna(s) 1005 and transceiver(s) 1010 described with reference to FIGS. 8, 9, and/or 10.

At block 1225, the device 805 may adapt the channel characteristic thresholds for the at least one group of client devices based on the received first message. The operation(s) at block 1225 may in some cases be performed using the channel characteristic threshold module 820 and/or the data rate controller 825 in conjunction with the transmitter 830 or antenna(s) 1005 and transceiver(s) 1010 described with reference to FIGS. 8, 9, and/or 10.

Thus, the method 1200 may provide for controlling data rates of groups of client devices 110 based on update data usage information and/or traffic information. It should be noted that the method 1200 is just one implementation and that the operations of the method 1200 may be rearranged or otherwise modified such that other implementations are possible.

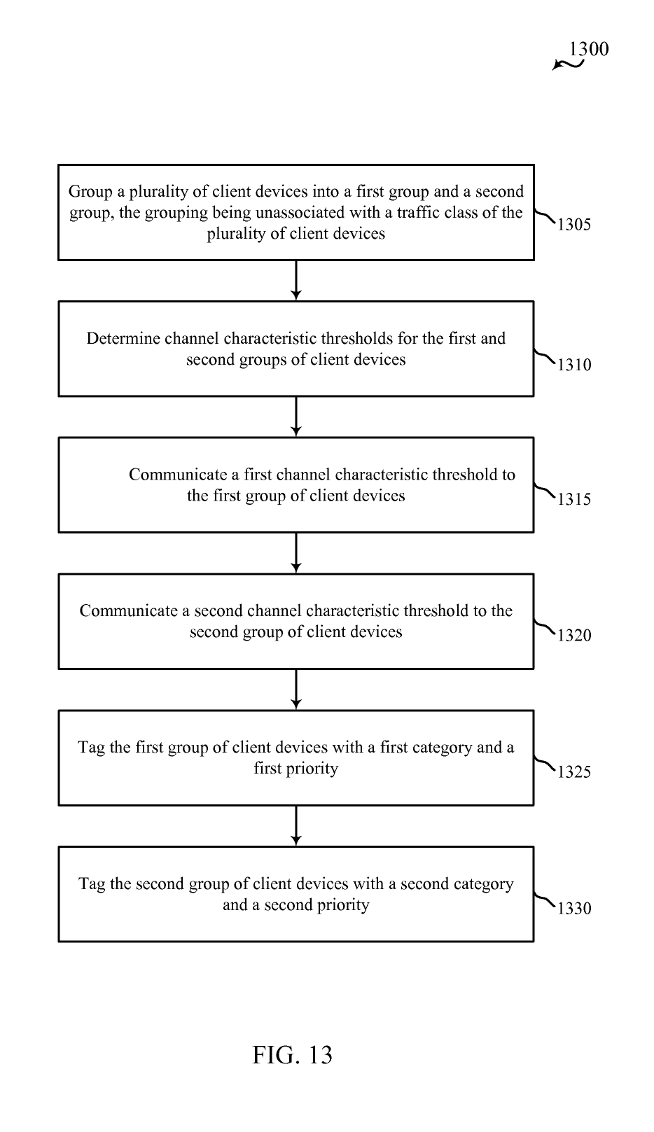

FIG. 13 is a flow chart illustrating another example of a method 1300 for controlling data rate(s) for groups of client devices 110 based on at least one channel characteristic thresholds, in accordance with various embodiments described herein. For clarity, the method 1300 is described below with reference to at least one aspect of an AP 105, client device 110 (acting as a soft AP), network device 305, and/or device 805 described with reference to previous Figures. In some embodiments, a device, such as one of the devices 805 or APs 105, may execute at least one set of codes to control the functional elements of the device to perform the functions described below.

At block 1305, a device 805 may group a plurality of client devices 110 into a first group and a second group (e.g., groups 205, 210, 330, 335, and/or 340 of FIGS. 2 and/or 3), the grouping being unassociated with a traffic class of the plurality of client devices 110. The operation(s) at block 1305 may in some cases be performed using the client device grouping module 815 described with reference to FIGS. 8, 9, and/or 10.

At block 1310, the device 805 may determine channel characteristic threshold(s) for first and second groups of client devices. The operation(s) at block 1310 may in some cases be performed using the channel characteristic threshold module 820 described with reference to FIGS. 8, 9, and/or 10.

At block 1315, the device 805 may communicate the first channel characteristic threshold to the first group of client devices. At block 1320, the device 805 may communicate the second channel characteristic threshold to the second group of client devices. The operations at block 1315 and 1320 may in some cases be performed using the data rate controller 825 in conjunction with the transmitter 830 or antenna(s) 1005 and transceiver(s) 1010 described with reference to FIGS. 8, 9, and/or 10. In some cases, the first and second channel characteristic thresholds may be communicated in two or more IEs 700 described in reference to FIG. 7.

At block 1325, the device 805 may tag the first group of client devices with a first category and a first priority. At block 1330, the device 805 may tag the second group of client devices with a second category and a second priority. The operations at block 1325 and 1330 may in some cases be performed using the client device grouping module 815 and/or memory 1025 of device 805 described with reference to FIGS. 8, 9, and/or 10.

Thus, the method 1300 may provide for controlling data rates of groups of client devices 110. It should be noted that the method 1300 is just one implementation and that the operations of the method 1300 may be rearranged or otherwise modified such that other implementations are possible.

Techniques described herein may be used for various wireless communications systems such as an IEEE 802.11 (Wi-Fi, Wi-Fi P2P, Wi-Fi Direct, etc.) system. The techniques described herein may be used for the systems and radio technologies mentioned above as well as other systems and radio technologies. The description above, however, describes a WLAN system for purposes of example, and WLAN terminology is used in much of the description above, although the techniques are applicable beyond WLAN applications.

For example, techniques described herein may be used for various wireless communications systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Throughout this disclosure the term “example” or “exemplary” indicates an example or instance and does not imply or require any preference for the noted example. Thus, the disclosure is not to be limited to the examples and designs described herein but is to be accorded the broadest scope consistent with the principles and novel features disclosed herein.

What is claimed is:

1. A method of limiting traffic in a WLAN, comprising:
grouping a plurality of client devices into at least one group, the grouping of the plurality of client devices being unassociated with a traffic class of the plurality of client devices;
determining channel characteristic thresholds for the at least one group of client devices; and
controlling a data rate for the at least one group of client devices based at least in part on the determined channel characteristic thresholds.

2. The method of claim 1, wherein controlling the data rate for the at least one group of client devices comprises:
communicating the channel characteristic thresholds to at least one of the plurality of the client devices in the at least one group.

3. The method of claim 2, wherein controlling the data rate for the at least one group of client devices further comprises:
receiving a first message from the at least one client device in response to the communicating; and
adapting the channel characteristic thresholds for the at least one group of client devices based on the received first message.

4. The method of claim 3, wherein the first message comprises traffic information for the at least one client device.

5. The method of claim 4, wherein the traffic information comprises at least one of data usage pattern information for at least one of the plurality of client devices in the at least one group, or type of client device for the at least one of the plurality of client devices in the at least one group, or priority of access for the at least one of the plurality of client devices in the at least one group, or a combination thereof.

6. The method of claim 2, wherein controlling the data rate for the at least one group of client devices further comprises:
detecting a change in traffic in the WLAN; and
adapting the channel characteristic thresholds for the at least one group of client devices based on the detected change in traffic.

7. The method of claim 2, wherein communicating the channel characteristic thresholds to the at least one of the plurality of the client devices in the at least one group comprises:
transmitting an information element (IE) to the at least one group of client devices, the IE comprising the channel characteristic thresholds, and at least one of a threshold application indication, or a threshold direction indication, or a group identification, or a combination thereof.

8. The method of claim 1, wherein the client devices in the at least one group support at least two types of traffic.

9. The method of claim 1, wherein the client devices in the at least one group support at least two types of priority.

10. The method of claim 1, wherein controlling the data rate for the at least one group of client devices comprises:
communicating a first channel characteristic threshold to a first group of client devices; and
communicating a second channel characteristic threshold to a second group of client devices.

11. The method of claim 10, further comprising:
tagging the first group of client devices with a first category and a first priority; and
tagging the second group of client devices with a second category and a second priority.

12. The method of claim 1, wherein the channel characteristic thresholds comprises at least one of a minimum bandwidth threshold, or a maximum bandwidth threshold, or a message size threshold, or a throughput threshold, or an optional service requirement, or a combination thereof.

13. The method of claim 1, wherein the channel characteristic thresholds for the at least one group of client devices comprises at least one of an uplink channel characteristic threshold, or a downlink channel characteristic threshold, or a combination thereof.

14. The method of claim 1, wherein the channel characteristic thresholds are received from a user interface.

15. The method of claim 1, wherein grouping the plurality of client devices into the at least one group is performed by at least one of an access point, or a soft access point, or a network device, or a combination thereof.

16. A wireless communications device comprising:
a client device grouping module to group a plurality of client devices in a WLAN into at least one group, the grouping of the plurality of client devices being unassociated with a traffic class of the plurality of client devices;
a channel characteristic threshold module to determine channel characteristic thresholds for the at least one group of client devices; and
a data rate controller to control a data rate for the at least one group of client devices based at least in part on the determined channel characteristic thresholds.

17. The wireless communications device of claim 16, wherein the data rate controller communicates the channel characteristic thresholds to at least one of the plurality of the client devices in the at least one group.

18. The wireless communications device of claim 17, wherein the channel characteristic threshold module receives a first message from the at least one client device in response to the communicating, and adapts the channel characteristic thresholds for the at least one group of client devices based on the received first message.

19. The wireless communications device of claim 17, wherein the channel characteristic threshold module detects a change in traffic in the WLAN, and adapts the channel characteristic thresholds for the at least one group of client devices based on the detected change in traffic.

20. The wireless communications device of claim 17, wherein the data rate controller communicates the channel characteristic thresholds to the at least one of the plurality of the client devices in the at least one group by transmitting an information element (IE) to the at least one group of client devices, the IE comprising the channel characteristic thresholds, and at least one of a threshold application indication, or a threshold direction indication, or a group identification, or a combination thereof.

21. An apparatus comprising:
means for grouping a plurality of client devices in a WLAN into at least one group, the grouping of the plurality of client devices being unassociated with a traffic class of the plurality of client devices;
means for determining channel characteristic thresholds for the at least one group of client devices; and
means for controlling a data rate for the at least one group of client devices based at least in part on the determined channel characteristic thresholds.

22. The apparatus of claim 21, further comprising:
means for communicating the channel characteristic thresholds to at least one of the plurality of the client devices in the at least one group.

23. The apparatus of claim 22, further comprising:
means for receiving a first message from the at least one client device in response to the communicating; and
wherein the means for controlling the data rate for the at least one group of clients devices comprises:
means for adapting the channel characteristic thresholds for the at least one group of client devices based on the received first message.

24. The apparatus of claim 22, wherein the means for controlling the data rate for the at least one group of client devices comprises:
means for detecting a change in traffic in the WLAN; and
means for adapting the channel characteristic thresholds for the at least one group of client devices based on the detected change in traffic.

25. The apparatus of claim 21, further comprising:
means for communicating a first channel characteristic threshold to a first group of client devices; and
means for communicating a second channel characteristic threshold to a second group of client devices.

26. The apparatus of claim 25, wherein the means for controlling the data rate for the at least one group of client devices comprises:
means for tagging the first group of client devices with a first category and a first priority; and
means for tagging the second group of client devices with a second category and a second priority.

27. A non-transitory computer-readable medium storing computer-executable code for wireless communication, the code executable by a processor to:
group a plurality of client devices into at least one group, the grouping of the plurality of client devices being unassociated with a traffic class of the plurality of client devices;
determine channel characteristic thresholds for the at least one group of client devices; and
control a data rate for the at least one group of client devices based at least in part on the determined channel characteristic thresholds.

28. The non-transitory computer-readable medium of claim 27, wherein the code is further executable by a processor to:
communicating the channel characteristic thresholds to at least one of the plurality of the client devices in the at least one group.

29. The non-transitory computer-readable medium of claim 28, wherein the code to control the data rate for the at least one group of client devices is further executable by a processor to:
receive a first message from the at least one client device in response to the communicating; and
adapting the channel characteristic thresholds for the at least one group of client devices based on the received first message.

30. The non-transitory computer-readable medium of claim 28, wherein the code to control the data rate for the at least one group of client devices is further executable by a processor to:
detect a change in traffic in the WLAN; and
adapt the channel characteristic thresholds for the at least one group of client devices based on the detected change in traffic.
